(19) United States
(12) Patent Application Publication
(10) Pub. No.: US 2009/0102176 A1
(43) Pub. Date: Apr. 23, 2009

(54) STABILIZING ROD FOR RETRACTABLE VEHICLE SUPPORTS

(76) Inventor: Bernard F. Garceau, Vandelia, MI (US)

Correspondence Address: HAHN LOESER & PARKS, LLP, One GOJO Plaza, Suite 300, AKRON, OH, 44311-1076, US

(21) Appl. No.: 11/876,002

(22) Filed: Oct. 22, 2007

(51) Int. Cl. B60S 9/02

(52) U.S. Cl. 280/763.1

(57) ABSTRACT

A stabilizing rod for a retractable stabilizing support for a vehicle, such as a recreational vehicle, a trailer, or the like, the stabilizing rod comprising: a longitudinally extendable and retractable member having a first end and a second end, the first end being configured to attach to one of a vehicle and a stabilizing support and the second end being configured to attach to the other of the vehicle and a stabilizing support, wherein one of the first and second ends includes a first rotation means that configured to rotate in more than one plane and the other of the first and second ends includes a second rotation means that rotates in at least one plane.

### FIELD OF THE INVENTION

The present invention relates to a stabilizing member for retractable vehicle and trailer supports. More specifically, the present invention relates to a stabilizing member for a retractable stabilizing jack for recreational vehicles, trailers, and the like.

### BACKGROUND OF THE INVENTION

Recreational vehicles and trailers typically incorporate spring suspension systems mounted between the chassis frame and the wheels to provide a smooth ride during transit. While such suspension systems enhance passenger comfort and minimize vibration, they often detract from the stability of the passenger compartment or trailer when parked. For example, when passengers move about the compartment, the vehicle tends to rock both fore and aft as well as from side to side. Furthermore, this rocking motion is enhanced due to the inherent flexibility of the wheels and slight rolling thereof in response to forward and rearward weight shifting within the vehicle cabin. The vehicle industry has addressed such vehicle stability concerns by developing various stabilizing supports or jack devices (collectively “stabilizing supports”) for use with the vehicles and trailers when stationary or parked. For example, such devices are disclosed in U.S. Pat. Nos. 3,565,396, 3,826,470, 5,205,586, and 7,249,754.

Stabilizing supports generally comprise leg-like and/or foot-like devices that are lowered to the ground to support or stabilize a recreational vehicle or trailer (collectively “vehicle”). Generally, these stabilizing supports are extendable and retractable, meaning that they translate and/or rotate between stored and operational positions. The stabilizing supports that include rotational operation generally do not effectively operate in a purely vertical plane. Instead, such supports provide both vertical (up and down) and horizontal (inward and outward) movements while being raised or lowered.

Stabilizing members or rods (collectively “stabilizing rods”) may be used to further strengthen and reinforce the stabilizing supports when extended for use. These stabilizing rods may operate in a plane normal or orthogonal to the plane in which the stabilizing support operates, and extend between the stabilizing support and the vehicle. Each stabilizing rod attaches to both the trailer and the support at respective connection points. Rods attach to the supports at a rod-support connection point. As the supports are raised and lowered, the stabilizing rods retract or extend, respectively, while rotating or pivoting about each connection point where each attaches to the trailer. In the prior art, each end of the rod may rotate in a single plane, or, in other words, the each end has a single rotational degree of freedom. These rods work well with rods that translate and rotate in a single plane, such as, without limitation, rods that operate in conjunction with purely vertical-translating stabilizing supports or where the rod-support connection point translates in a vertical line. However, when the stabilizing support translates horizontally during raising or lowering actions or where the rod-support connection point translates both vertically and horizontally, the rod experiences undue stresses because it cannot translate or rotate horizontally (sideways) in response to the horizontal movement of the stabilizing support, which is seen by rod as a side movement or force. As a result of using these rods with rotating stabilizing supports, the stabilizing rods may become damaged or even fail during use. Therefore, there is a need to provide a stabilizing rod that is able to operate with rotating stabilizing supports.

### SUMMARY OF THE INVENTION

A particular embodiment of the present invention includes a stabilizing rod for a retractable stabilizing support for a recreational vehicle, the stabilizing rod comprising: a longitudinally extendable and retractable member having a first end and a second end, the first end being configured to attach to one of a vehicle and a stabilizing support and the second end being configured to attach to the other of the vehicle and a stabilizing support, wherein one of the first and second ends includes a first rotation means that configured to rotate in more than one plane and the other of the first and second ends includes a second rotation means that rotates in at least one plane.

Another embodiment of the present invention includes a stabilizing rod for a retractable stabilizing support for a recreational vehicle, the rod comprising: a longitudinally extendable and retractable member having a first end and a second end; the first end having a multi-planar rotation means, the means providing multi-planar rotation between the vehicle and the stabilizing rod; and the second end having a second rotation means, the means providing rotation between the stabilizing support and the stabilizing rod in at least a single plane.

Another embodiment of the present invention includes a stabilizing support system for a recreational vehicle, the system comprising: a stabilizing support comprising a stabilizing jack; a stabilizing rod configured to be operably attached to the stabilizing support and the vehicle, the rod comprising: a longitudinally extendable and retractable member having a first rotation means and a second rotation means; the first rotation means providing multi-planar rotation between the vehicle and the stabilizing rod; and, the second rotation means providing rotation between the stabilizing support and the stabilizing rod in at least a single plane.

These and other advantages will be apparent upon a review of the detailed description of the invention.

### BRIEF DESCRIPTION OF THE DRAWINGS

FIG. 1 is a perspective view of a stabilizing rod in accordance with an embodiment of the present invention.

FIG. 2 is a side view of the stabilizing rod shown in FIG. 1.

FIG. 3 is an exploded perspective view of a first end of the stabilizing rod as shown in FIG. 1.

FIG. 4 is a close-up perspective view of a second end of the stabilizing rod as shown in FIG. 1.

FIG. 5 is a side view of the stabilizing support, showing potential paths of the rod-support connection point during operation of exemplary stabilizing supports.

FIG. 6 is a perspective view showing the stabilizing rod of FIG. 1 attached to a stabilizing jack and a portion of a vehicle, with the rod in a stored or collapsed position.

FIG. 7 is a side view showing the stabilizing rod of FIG. 1 attached to a stabilizing jack and a portion of a vehicle, with the rod in a stored or collapsed position.

FIG. 8 is a perspective view showing the stabilizing rod of FIG. 1 attached to a stabilizing jack and a portion of a vehicle, with the rod in a partially extended or retracted position.

FIG. 9 is a side view showing the stabilizing rod of FIG. 1 attached to a stabilizing jack and a portion of a vehicle, with the rod in a partially extended or retracted position.

FIG. 10 is a perspective view showing the stabilizing rod of FIG. 1 attached to a stabilizing jack and a portion of a vehicle, with the rod in a fully extended position.

FIG. 11 is a side view showing the stabilizing rod of FIG. 1 attached to a stabilizing jack and a portion of a vehicle, with the rod in a fully extended position.

### DETAILED DESCRIPTION OF THE DRAWINGS

With reference to the figures, recreational vehicles or trailers (collectively “vehicles”) 2 often utilize retractable stabilizing supports 4, such as without limitation stabilizing jacks, one of which is shown in the figures, to maintain the vehicle in a level and stable stationary position.

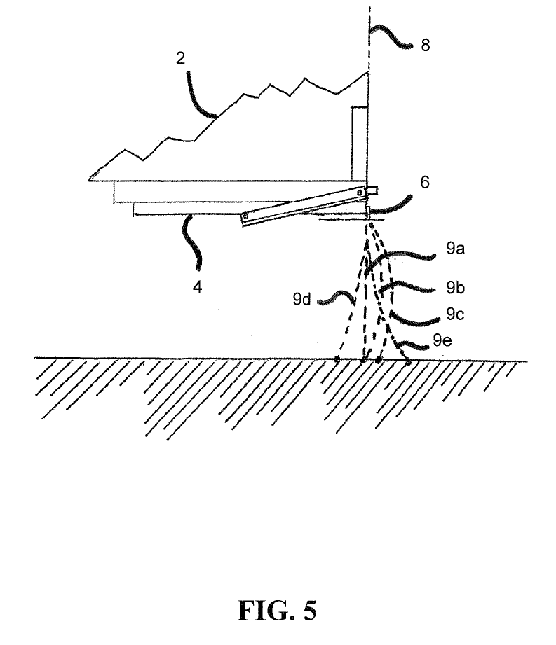

To provide additional stability and rigidity to stabilizing supports 4 and vehicle 2, stabilizing members or rods (collectively “stabilizing rods”) 10 may be secured between the stabilizing support 4 and the vehicle 2. When the stabilizing support 4 is extended for use or retracted for storage, the stabilizing rod 10 may generally remain attached to each of the support 4 and vehicle 2 at respective connection points. Although not necessary to practice this invention, the rod-trailer connection point generally remains stationary while the rod-support connection point moves with the extension and retraction of the support 4. To achieve this, the rod 10 may be generally capable of rotating within a single plane (a single rotational degree of freedom) at its connection points and/or adjusting its length during extension and retraction of support 4. However, the support 4 may not simply translate in a purely vertical direction, and rod 10 may not operate in a single plane. In other words, and with reference to FIG. 5, the point at which rod 10 attaches to support 4, i.e., the rod-support connection point 6, may not translate solely in a vertical line or within vertical plane 8, which is substantially normal to the plane in which support 4 operates (the “support plane”). Instead, the support 4 may rotate between stored and extended positions so to cause at least a portion of the support 4, such as without limitation the rod-support connection point 6, to translate horizontally (i.e., sideways or transversely) outward of plane 8 (i.e., the plane normal to the support plane). In FIG. 5, translation of connection point 6 in a purely vertical direction within plane 8 is represented by path 9a. Paths 9b-9e represent exemplary paths that may operate outside plane 8, such as in the support plane discussed above, but in no way represent all possible paths rod-support connection point 6 may navigate, which is unlimited and includes inwardly and outwardly arced paths.

In one exemplary embodiment, stabilizing rod 10 may be mounted to a side of support 4 at a rod-support connection point 6, where the connection point 6 translates vertically and horizontally in the support plane upon operation of support 4. In other words, the rod-support connection point 6 may translate in and out of vertical plane 8 (i.e., the plane normal to the support plane). In operation, rod 10 rotates and translates with operation of support 4, and the horizontal translation of the support 4 causes side forces to act upon stabilizing rod 10. To allow rod 10 to respond to this compound translation scenario, and to avoid any detrimental stresses and binding of the rod 10 during extension and retraction, a connection having a second rotational degree of freedom is provided, which may include, without limitation, at least one universal or ball joint, which is located at an end 30, 40 of rod 10. Now, rod 10 may translate sideways while the support is being raised or lowered, which results in a more fluent operation of the rod 10 with reduced stresses. Also, these improvements help to avoid rod and connection failures, which may result in catastrophes due to their use on vehicles. It is contemplated that the support 4 and rod 10 may be used on any vehicle or trailer, regardless of whether it is recreational.

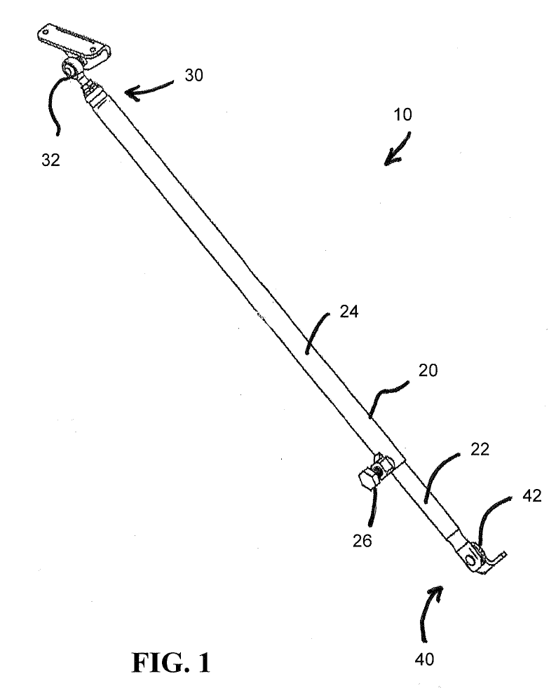

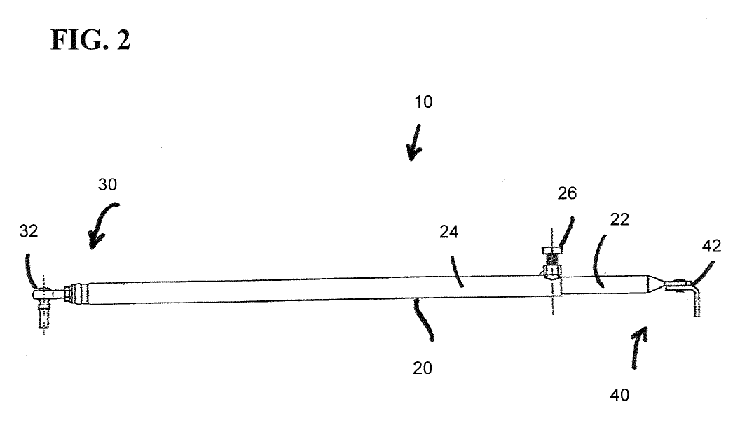

In FIGS. 6-11, stabilizing rod 10 is shown operably attached to a vehicle 2 and a stabilizing support 4. With reference to FIGS. 1-4, the stabilizing rod 10 generally includes an adjustable length shaft 20, a locking means 26, a first rotation means 32 located at a first end 30 of shaft 20, and a second rotation means 42 located at a second end 40 of shaft 20.

Shaft 20 has an adjustable length so that it may extend and retract as the support 4 is raised and lowered. In one embodiment, the shaft 20 is telescoping, which means that shaft 20 comprises a first section 22 and a second section 24, where one of the sections translates within the other section. Shaft 20 may be formed of any desired material suitable for its purpose, which includes, without limitation, any steel or aluminum alloy. Sections 22, 24 may also comprise any suitable form, such as without limitation tubes (square, round, or the like) or channels and solid bars (each of which would require a side-by-side orientation or translation—as opposed to a telescoping orientation). A locking means 26 may exist for locking the sections 22, 24 relative to each other. In one embodiment, the locking means is attached to one of the sections 22, 24 and comprises a threaded bolt 28 and housing 29. It is contemplated that other locking means may be used, including without limitation a pin.

Shaft 20 also has a first end 30 and a second end 40. First end 30 attaches to a portion of the vehicle 2 and the second end 40 attaches to the stabilizing support 4. Each of the ends 30, 40 rotate with respect to that which it attaches to, namely, the vehicle 2 and the support 4, respectively. At least one of the ends 30, 40 is capable of rotating in more than one plane (“multi-planar rotation”). In other words, at least one of the ends 30, 40 has at least two rotational degrees of freedom. Being able to rotate solely in vertical plane 8, as in the prior art, provides a single rotational degree of freedom. In one exemplary embodiment, at least one of the ends 30, 40 is capable of both axial rotation (rotation about an axis) and rotation of the rotational axis (pivoting an axis about a point). In another exemplary embodiment, at least one of the ends 30, 40 is capable of rotation in two of three planes consisting of the support plane, the vertical plane 8, and the plane normal to each of the support plane and the vertical plane 8.

Multi-planar rotations may be achieved by a rotation means, which includes, without limitation, a ball-and-socket joint (such as a rod end) or a universal joint, or by utilizing more than one rotation means, where each rotation means is capable of rotating in different planes. For example, one rotation means may comprise a pin extending perpendicularly through shaft 20 and into a bracket, while a hinge rotating in a different plane may extend from the bracket and attach to the vehicle 2 or support 4.

In the figures, and shown in more detail in FIG. 3, the first end 30 includes a first rotation means 32 that provides multi-planar rotation. In one embodiment, the first rotation means 32 is a ball-and-socket joint (such as a rod-end) or a universal joint. It is contemplated that any other joint known to one of ordinary skill in the art that is capable of rotating rod 10 in multiple planes may be used. As discussed above, it is also contemplated that the multi-planar rotation may be achieved by two or more rotation means.

First rotation means 32 is attached to the shaft 20, directly or indirectly, and a portion of the vehicle 2. Each attachment of first rotation means 32 may accomplished by way of a weld, pin, threaded shaft, fastener, and/or any other means known to one of ordinary skill in the art, and may be fixed, rotational, or pivotable. In the embodiment shown in the FIGS. 1-4, a first threaded shank 34 extends into an internally threaded first end 30 of shaft 20 and is locked in place by a hex jam nut 35. In the same embodiment, a second threaded shank 36 of first rotation means 32 is secured to a mounting bracket 38 by a nut 37. The mounting bracket 38 is attached to the vehicle 2. It is contemplated, however, that bracket 38 may not be used, as first rotation means 32 may extend between shaft 20 and vehicle 2.

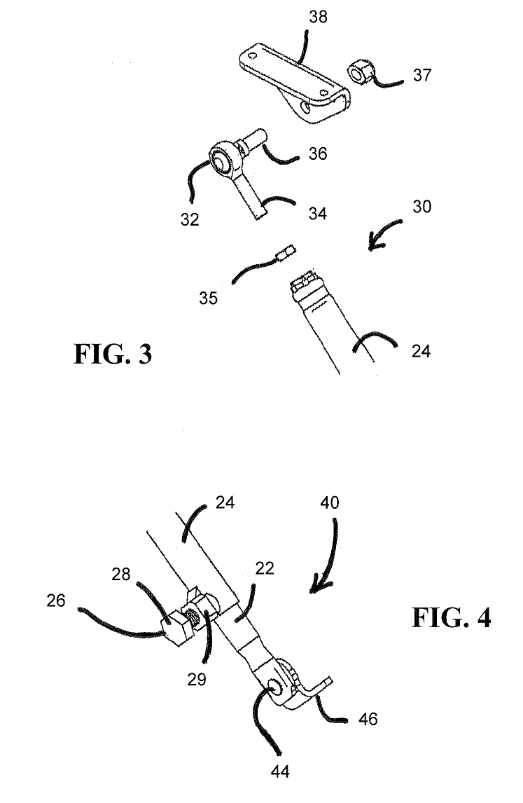

Rod 10 also includes a second rotation means 42, located at the second end 40. Second rotation means 40 at least allows the second rod end 40 to rotate in one plane. In the embodiment shown in the figures, and in more detail in FIG. 4, the second rotation means 42 comprises a pin 44 that extends between adjustable shaft 20 (second section 24) and a mounting bracket 46. Pin 44 is crimped on both ends to secure pin 44 within shaft 20 and bracket 46. Second end 40 may be crimped or flattened to better facilitate joiner and relative rotation with bracket 46. It is contemplated that in lieu of pin 44, any other fastening device may be used, such as, without limitation, a nut and bolt. It is also contemplated that bracket 46 may not be used, as second rotation means 42 may extend between shaft 20 and stabilizing support 4. Second rotation means 42 may also comprise a multi-planar rotation joint, as discussed with reference to first rotational means 32.

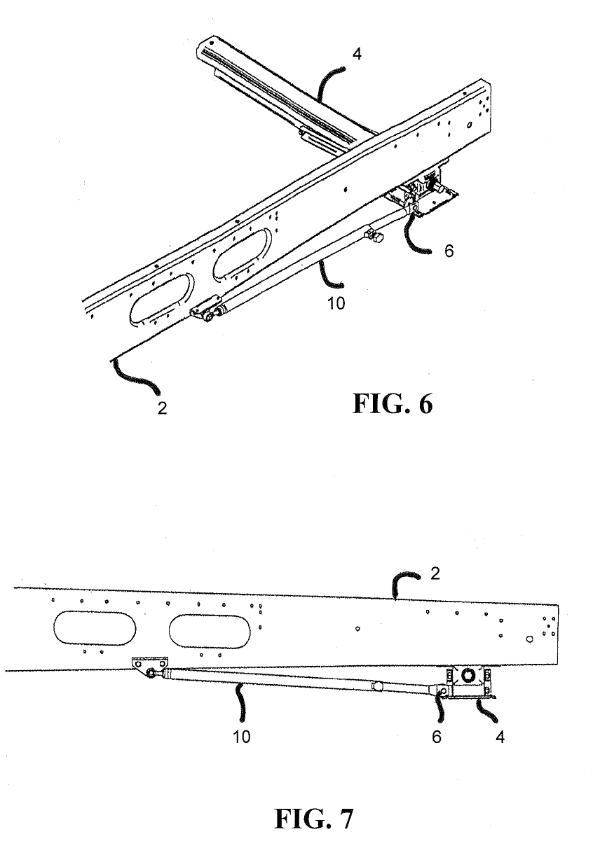

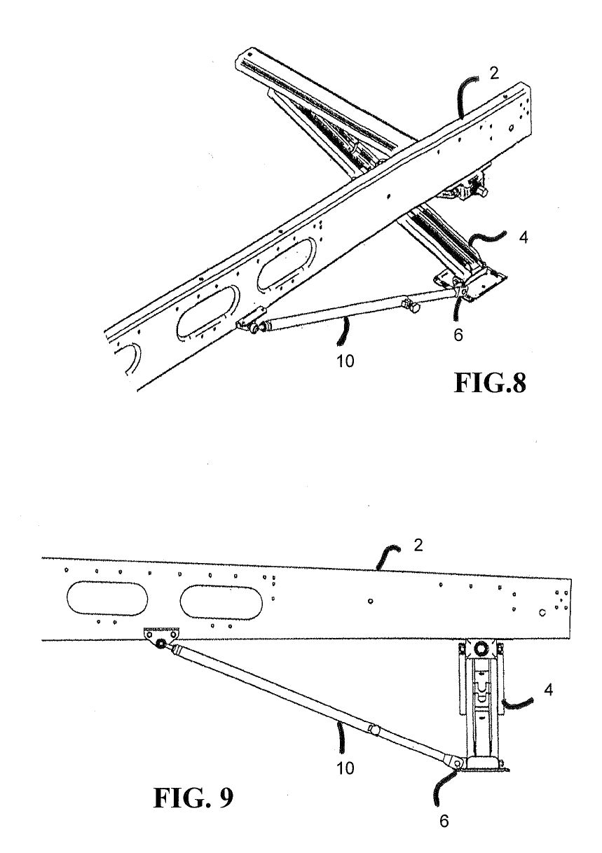

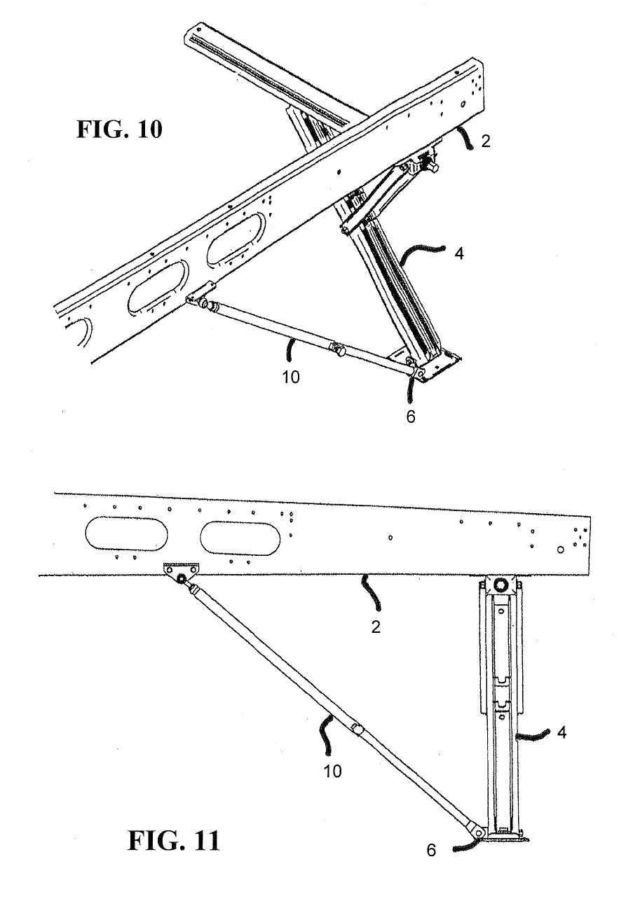

In operation, when stabilizing support 4 is lowered in relation to vehicle 2, such as from a stored position as shown in FIGS. 6-7, stabilizing rod 10 extends. As support 4 continues to lower, as shown in FIGS. 8-9, support 4 translates and rotates. This causes rod-support connection point 6 to translate vertically and horizontally within a plane, such as the support plane. To avoid any stresses in rod 10 arising from a side load caused by the horizontal movement of support 4, the rod 10 pivots pursuant first rotational means 32 (and second rotational means 42 if it is a multi-planar joint) to allow for the horizontal movement. This pivoting combines with the downward rotation caused by the lowering of support 4, to provide multi-planar rotation. Once the support 4 is extended for use, as shown in FIGS. 10-11, locking means 26 may then be engaged to secure the rod 10 in an extended position. When it is determined that support 4 is to be raised, locking means 26 is disengaged so that rod 10 (shaft 20) may retract or collapse. Rod 10 may then pivot, as it did in the lowering stage, to avoid any binding or stresses arising from any horizontal movement of support 4.

The invention has been described with reference to a various embodiments and alternates thereof. It is believed that many modifications and alterations to the embodiments disclosed will readily suggest themselves to one skilled in the art upon reading and understanding the detailed description of the invention. It is intended to include within the scope of this invention all such modifications and alterations in so far as they come within the scope of the present invention.

I claim:

1. A stabilizing rod for a retractable stabilizing support for a recreational vehicle, the stabilizing rod comprising:
a longitudinally extendable and retractable member having a first end and a second end, the first end being configured to attach to one of a vehicle and a stabilizing support and the second end being configured to attach to the other of the vehicle and a stabilizing support,
wherein one of the first and second ends includes a first rotation means that configured to rotate in more than one plane and the other of the first and second ends includes a second rotation means that rotates in at least one plane.

2. The stabilizing rod as recited in claim 1, wherein the first rotation means comprises a ball-and-socket joint.

3. The stabilizing rod as recited in claim 1, wherein the first rotation means comprises a universal joint.

4. The stabilizing rod as recited in claim 1, wherein the longitudinally extendable and retractable member is a telescoping member.

5. The stabilizing rod as recited in claim 4, wherein the longitudinal member includes a constraining means, the means configured to restrict the extension and/or retraction of the longitudinal member.

6. The stabilizing rod as recited in claim 1, wherein the stabilizing support is a stabilizer jack.

7. A stabilizing rod for a retractable stabilizing support for a recreational vehicle, the rod comprising:
a longitudinally extendable and retractable member having a first end and a second end;
the first end having a multi-planar rotation means, the means providing multi-planar rotation between the vehicle and the stabilizing rod; and
the second end having a second rotation means, the means providing rotation between the stabilizing support and the stabilizing rod in at least a single plane.

8. The stabilizing rod as recited in claim 7, wherein the first rotation means comprises a ball-and-socket joint.

9. The stabilizing rod as recited in claim 7, wherein the first rotation means comprises a universal joint.

10. The stabilizing rod as recited in claim 7, wherein the longitudinally extendable and retractable member is a telescoping member.

11. The stabilizing rod as recited in claim 10, wherein the longitudinal member includes a constraining means, the means configured to restrict the extension and/or retraction of the longitudinal member.

12. The stabilizing rod as recited in claim 7, wherein the stabilizing support is a stabilizer jack.

13. A stabilizing support system for a recreational vehicle, the system comprising:
a stabilizing support comprising a stabilizing jack;
a stabilizing rod configured to be operably attached to the stabilizing support and the vehicle, the rod comprising:
a longitudinally extendable and retractable member having a first rotation means and a second rotation means;
the first rotation means providing multi-planar rotation between the vehicle and the stabilizing rod; and
the second rotation means providing rotation between the stabilizing support and the stabilizing rod in at least a single plane.

14. The stabilizing rod as recited in claim 13, wherein the first rotation means comprises a ball-and-socket joint.

15. The stabilizing rod as recited in claim 13, wherein the first rotation means comprises a universal joint.

16. The stabilizing rod as recited in claim 13, wherein the longitudinally extendable and retractable member is a telescoping member.

17. The stabilizing rod as recited in claim 16, wherein the longitudinal member includes a constraining means, the means configured to restrict the extension and/or retraction of the longitudinal member.

18. The stabilizing rod as recited in claim 13, wherein the stabilizing support is a stabilizer jack.
